(19) United States
(12) Patent Application Publication
(10) Pub. No.: US 2008/0311379 A1
(43) Pub. Date: Dec. 18, 2008

(54) Apparatus & Method for Manufacturing a Reinforced Low-Density Insulative Material

(75) Inventor: Harold G. Messenger, Rehoboth, MA (US)

Correspondence Address: SHERIDAN ROSS PC, 1560 BROADWAY, SUITE 1200, DENVER, CO, 80202, US

(73) Assignee: Oldcastle Precast, Inc., Rehoboth, MA (US)

(21) Appl. No.: 12/138,557

(22) Filed: Jun. 13, 2008

Related U.S. Application Data
(60) Provisional application No. 60/943,972, filed on Jun. 14, 2007.

(51) Int. Cl. B32B 5/28; B29C 67/20

(52) U.S. Cl. 428/319.9; 264/46.4

(57) ABSTRACT

A reinforced low density material is provided that includes a reinforcing mesh or other geometry. The reinforcing mesh in one embodiment of the present invention is comprised of an arrangement of glass fibers that are coated with a polymer. The insulative material is formed by placing the reinforcing mesh within a mold, wherein the introduction of a heated expanded polystyrene, for example causes the coating on the reinforced mesh 1 to bond with the polystyrene to create a reinforced insulative material after the composite material cools.

This application claims the benefit of pending U.S. Provisional Patent Application Ser. No. 60/943,972, filed Jun. 14, 2007, the entire disclosure of which is incorporated by reference herein.

### FIELD OF THE INVENTION

The present invention is generally related to reinforced insulation that may be integrated into concrete wall panels or any other device that employs insulative material.

### BACKGROUND OF THE INVENTION

Insulating material is often fabricated from molten polystyrene that is either introduced into a mold to form expanded polystyrene (EPS) foam or extruded to form extruded polystyrene (XPS) foam which is then cut to the required dimension. EPS, the insulative foam most often found in low-density concrete wall panels, for example, is very brittle and prone to cracking and is not designed to resist bending, torsional, tension, or compressive loading. Thus EPS is often damaged during handling which may not be evident until concrete is introduced to a wall form containing the insulative material. Weakened insulative material may also compromise the structural integrity of the finished concrete wall panel. It is thus desirable to provide a concrete wall panel with an insulative material that is stronger, more durable and are more apt to support the weight of concrete during formation. By increasing the performance characteristics of the low density foam material, reduced thicknesses can be used with equivalent strength, thus significantly removing material costs.

It is desirable to add structural reinforcement to any type of insulation. More specifically, items such as Styrofoam® coolers, thermoses, and other building materials that utilize insulative materials are also very brittle and apt to break. Thus it is desirable to provide insulative material that is reinforced, thereby protecting the insulative material against damage and, in some instances, making the item to which they are integrated into stronger.

Thus it is a long felt need to provide a reinforced low density insulative material that resists damage. The following disclosure describes an improved reinforced insulative material for use in, among other things, low density concrete wall or foundation panels.

### SUMMARY OF THE INVENTION

It is one aspect of the present invention to provide a reinforced, low density insulative material. More specifically, in one embodiment, a reinforced insulated cavity former is provided for incorporation within a low-density wall panel. Instead of using large EPS blocks that are often formed in 8′×8′×30′ sections and cutting them into sheets of 4′×8′×2″ for use in the wall panel, the cavity former is preformed and includes an embedded reinforcing mesh. The reinforced mesh is preferably comprised of fiberglass that is coated with polyvinyl chloride (PVC). The use of PVC coating is advantageous since it reacts with the heated EPS during formation to create an enhanced bond between the reinforcing mesh and the EPS foam. The reinforcing mesh may be in the form of strips or sheet, which will be apparent upon review of the detailed description below.

In operation, reinforcing mesh is placed in a mold at a predetermined location to yield an insulative material with improved strength and rigidity. Another significant benefit provided by embodiments of the invention is the increased strength to weight ratio of the insulative material which allows smaller or thinner insulative members to be used which significantly decreases cost. Although described thus far is a reinforced insulative material for integration into a wall panel, one skilled in the art will appreciate that other devices that include insulation may also be benefitted by the use of reinforcement. For example, beverage coolers, thermoses, or other devices that employ insulating material may be strengthened. Further, automobiles may employ insulative materials to reduce weight and reinforced insulative materials as disclosed and contemplated herein are well suited to accomplish this task.

As briefly mentioned above, one embodiment of the present invention possesses enhanced bonding characteristics between the PVC coated reinforcing mesh and the EPS foam. That is, the PVC coating and raw polystyrene have approximately the same melting point. Thus, during the molding process, the molten EPS will tend to melt the PVC coating, thereby facilitating a mechanical and/or chemical bond between the polystyrene and the PVC. It is important to note that the heat from the EPS does not destroy the PVC bonds (often known as “beads”) that interconnect the individual fiber strands that make up the reinforcing mesh. More specifically, often the mesh reinforcement is created not by weaving, but by placing glass fibers in one direction onto glass fiber oriented in another direction and by dipping this fibergrid into a liquid PVC bath. The beads that are present at fiber crossings hold the individual fibers together.

As briefly mentioned above, one advantage of employing reinforced insulative material is a decrease in cost. More specifically, costs related to handling, shipping, cutting and waste disposal of large insulative foam blocks is often an obstacle of the construction of components that utilize insulation. In some applications, embodiments of the present invention reduce the amount of insulating foam needed by ten times the amount normally used. That is, due to their increased strength, insulative material with a decreased cross-sectional area or shape may be employed, which significantly reduces the amount of insulation required. Further, the enhanced strength of components that employ reinforced insulative materials increase the aggregate strength of the component, which should be apparent to one skilled in the art. Other advantages of the invention will also be apparent to one skilled in the art upon review of the following disclosure.

It is also an aspect of the present invention to provide a method of manufacturing a reinforced insulative material with a predetermined shape, comprising:

providing a mold with a first portion and a second portion which has a predetermined shape;

positioned a reinforcing material between said first portion and said second portion at a predetermined location;

closing said mold to retain said reinforcing material within the first portion and the second portion;

placing a volume of foam material at a predetermined temperature into said mold;

providing heat to the mold until it reaches a predetermined temperature;

bonding said reinforcing material to said foam within said mold;

cooling said reinforced low density foam material; and

removing said low density reinforced foam material from said mold.

It is yet another aspect of the present invention to provide a reinforced low density structure, comprising:

a low density foam material with a predetermined shape and having a first thickness defined by a distance between a first surface and a second surface; and

a reinforcing mesh positioned between said first and said second surface of said low density foam material.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of these embodiments.

FIG. 1 is a perspective view of a reinforced cavity former for integration into a low-density wall panel;

FIG. 2 is a front elevation view of a mold for forming the reinforced cavity former shown in FIG. 1;

FIG. 3 is a right elevation view of the mold shown in FIG. 2;

FIG. 4 is a partial perspective view of a thermos that employs a reinforced insulative core;

FIG. 5 is a partial perspective view of a food and beverage cooler that employs a reinforced insulative material;

FIG. 6 is a front cross-sectional view of reinforcing mesh of one embodiment of the present invention;

FIG. 7 is a front cross-sectional view of another embodiment of the reinforcing mesh;

FIG. 8 is a front cross-sectional view of the reinforcing mesh shown in FIG. 6 that has been coated; and

FIG. 9 is a front cross-sectional view of the coated reinforcing mesh shown in FIG. 8 and embedded in an insulative material.

To assist in the understanding of the present invention the following list of components and associated numbering found in the drawings is provided herein:

| # | Component |
|---|---|
| 2 | Reinforced insulative material |
| 2a | Cavity former |
| 2b | Thermos core |
| 6 | Reinforcing mesh |
| 10 | Coating |
| 14 | Mold |
| 18 | Insulation |
| 20 | Cooler |
| 22 | Cavity |
| 26 | Roll |
| 30 | Upper mold |
| 34 | Lower mold |
| 38 | Fiber |
| 44 | Transverse fiber |
| 48 | Longitudinal fiber |
| 52 | Warp |
| 56 | Weft |
| 60 | Interface boundary |
| 64 | Bead |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

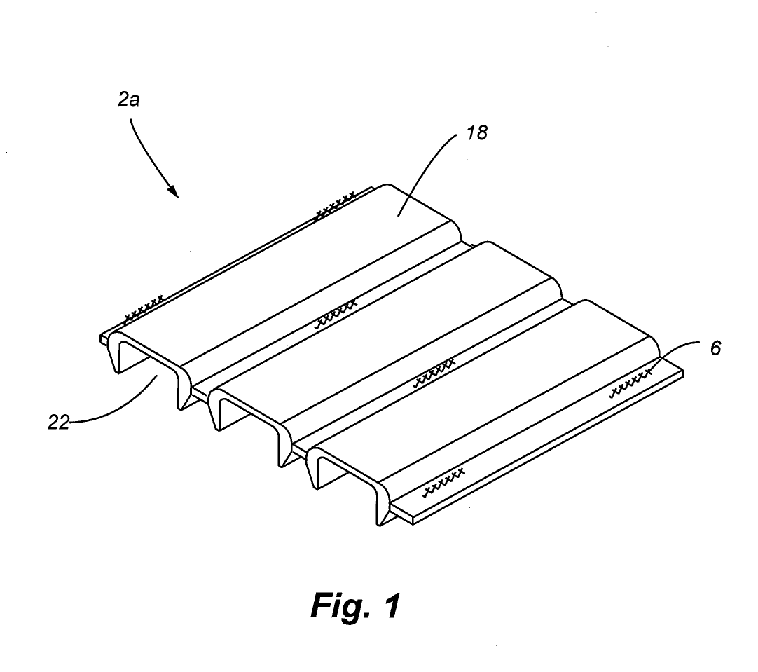

Referring now to FIGS. 1-9, a reinforced insulative material 2 is provided herein. During fabrication of one embodiment of the invention, fiberglass mesh 6 is coated with polyvinyl chloride (PVC) 10 and is positioned within a mold 14. Thereafter, heated expanded polystyrene (EPS) 18 is added to the mold 14 to form a reinforced insulative material 2 of a predetermined shape. The heat of the molten EPS 18 is approximately the same as the melting point of the PVC coating 10 of the reinforcing mesh 6 so that during fabrication, a strong mechanical and/or chemical bond is formed between the EPS insulation 18 and the PVC coated mesh 6 to provide a strengthened component.

Referring now to FIGS. 1-3, a cavity former 2a reinforced insulative material in one embodiment of the present invention is provided that is designed to form a plurality of cavities 22 within a manufactured low-density wall panel. The cavity former 2a is comprised of a planar surface with two legs extending therefrom that define the cavity 22. During fabrication, the reinforcing mesh 6 is added to the EPS foam insulation 18 of which one embodiment of the present invention is constructed to increase the strength and stiffness of the finished cavity former 2a. The reinforcing mesh 6 may be added to the cavity former mold 14 via a plurality of strips or a sheet.

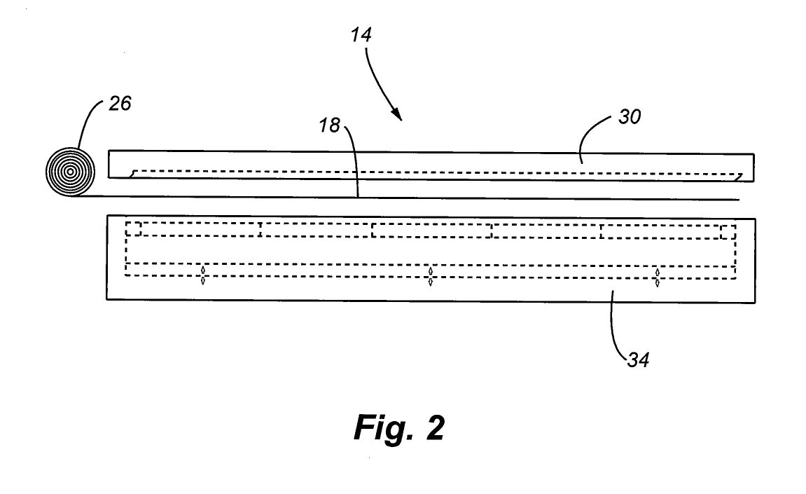

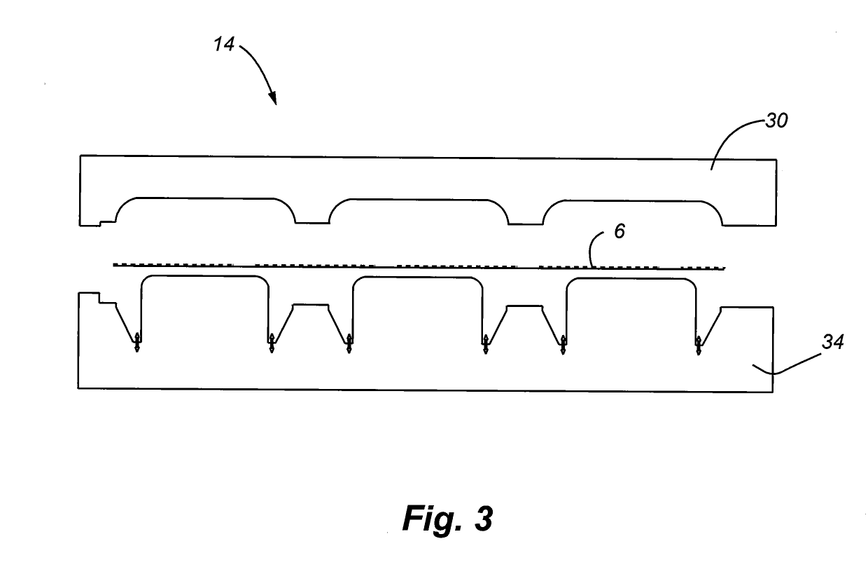

In operation, a roll 26 of reinforcing mesh 6, which is preferably coated with PVC 10, is positioned between an upper mold 30 and a lower mold 34. The roll 26 may be comprised of a sheet of reinforcing mesh 6 that extends the entire width of the mold 14 or a plurality of discreet mesh strips that are positioned at varying locations within the mold 14. FIG. 3 which is a right elevation view of FIG. 2, illustrates how the reinforcing mesh 6 can be a continuous sheet that is positioned between the upper mold 30 and the lower mold 34. One skilled in the art will appreciate that the reinforcing mesh 6 possesses any orientation of fibers 38, such as random, 0 degrees and 90 degrees, 45 and 45 degrees, etc. to provide the desired composite material properties. Further, it is contemplated that more than one sheet or layers of reinforcement 6, may be employed. More specifically, it is envisioned that multiple spaced layers of reinforcement 6 be employed, which may be oriented relative to each other.

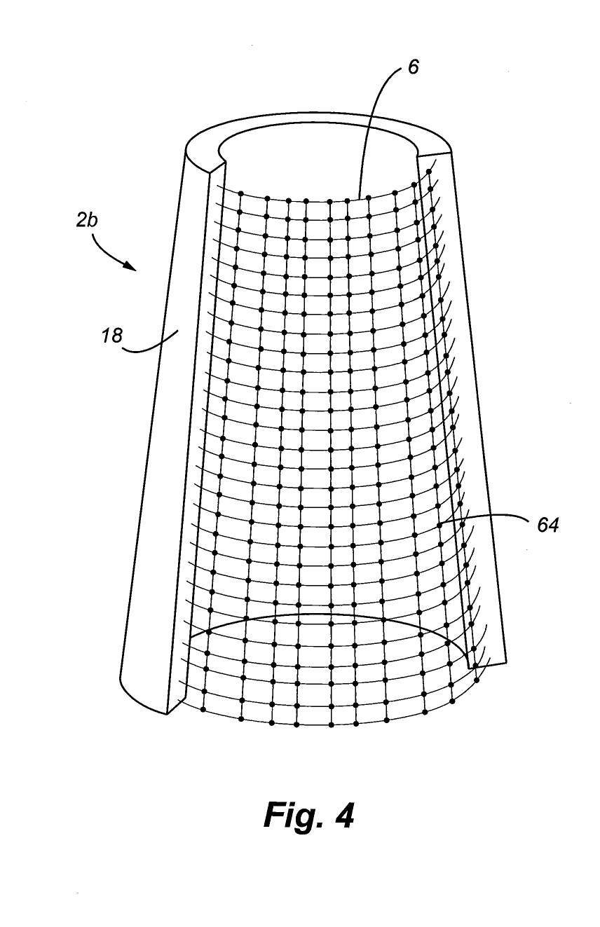

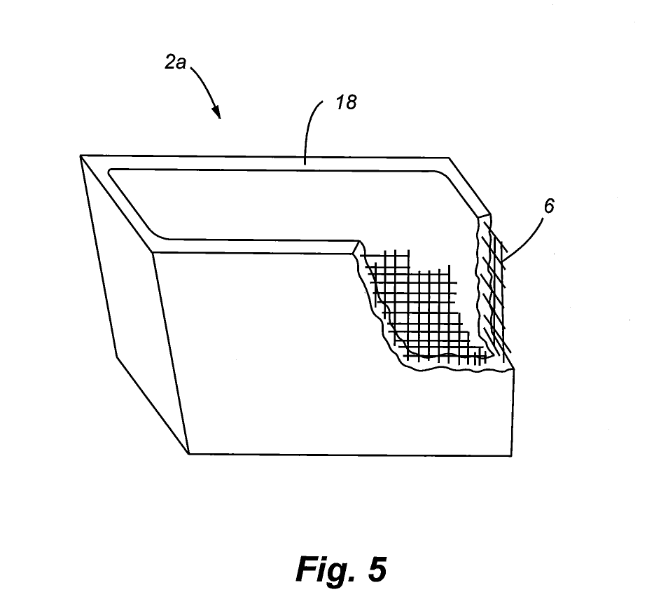

Referring now to FIGS. 4 and 5, other components that utilize embodiments of the present invention are provided. More specifically, one skilled in the art will appreciate that other uses for embodiments of the present invention are possible. For example, FIG. 4 shows a core of a common thermos 2b wherein the outer plastic shell and the inner shell that contains the liquid has been removed for clarity. The thermos 2b is reinforced with a conical web of reinforcing mesh 6 that is embedded within the thickness of the insulative material 18 that keeps the stored beverage within the thermos hot or cold. Although reinforcing a thermos 2b may seem unnecessary, it is often desirable to have strong low density materials for camping or military applications. That is, this example is provided to simply show that embodiments of the present invention can be used in various applications.

Referring now specifically to FIG. 5, a more common application of the embodiments of the present invention is provided. More specifically, here a common styrofoam cooler 2a is enhanced by the use of a mesh 6 material embedded within the insulative material 18. Often, these coolers 2a are fairly inexpensive wherein they are constructed entirely of Styrofoam® and thus disposable. Due to environmental concerns, the use of a reinforced insulative material would give the cooler 2a more rigidity in strength, thereby increasing the coolers' 2a lifespan. One skilled in the art will appreciate that often all coolers 2a employ an insulative material that is coated with a hard plastic material to provide rigidity and a more permanent cooler for a user. Again, applications as taught herein are well suited for the construction of such coolers.

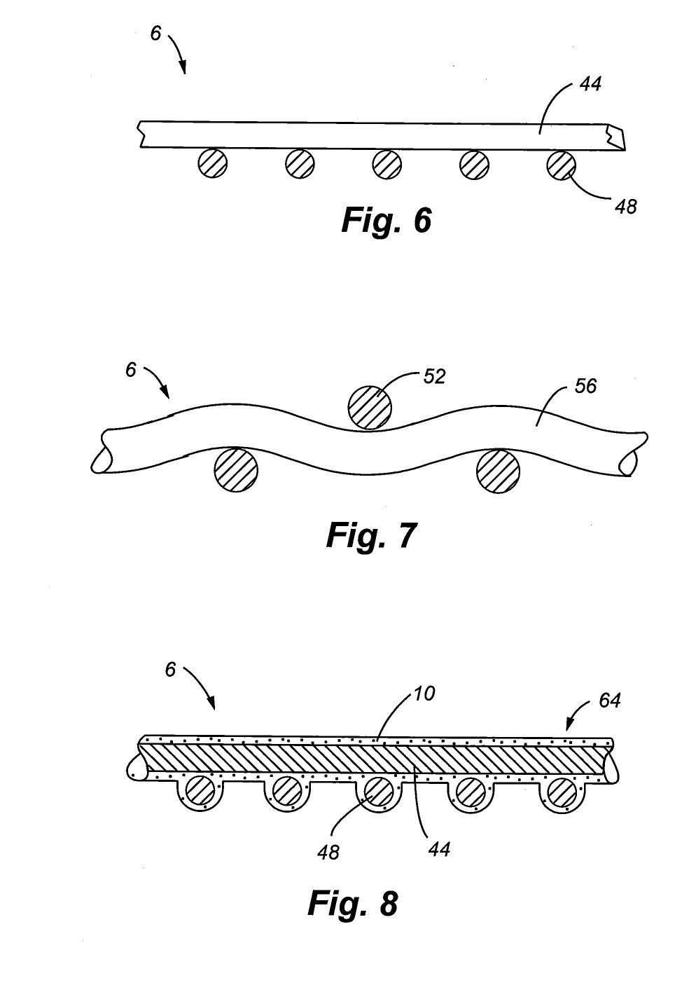

Referring now to FIGS. 6 and 7, the reinforcing mesh 6 employed by some embodiments of the present invention is shown. As indicated above, the reinforcing mesh 6 may be composed of fiberglass fibers 38, carbon fiber fibers or any other fibers known in the art. The fibers 38 are oriented in some instances in a 0 degree, 90 degree fashion wherein transverse fibers 44 are laid over longitudinal fibers 48. Some embodiments of the present invention, with reference to FIG. 7, employ a weave wherein a warp 52 and a weft 56 is employed to enhance the strength of the mesh 6 and thus the finished reinforced insulative material.

Referring now to FIG. 8, a coated reinforcing mesh 6 is provided. In order to bond the transverse 44 and longitudinal fibers 48, or the warp and a weft, whatever the case may be, the oriented fibers 38 are dipped in a bath of a coating material 10. Preferably, the coating material 10 is PVC. After the group of fibers 38 is lifted from the bath, they are bonded to create the reinforcing mesh 6.

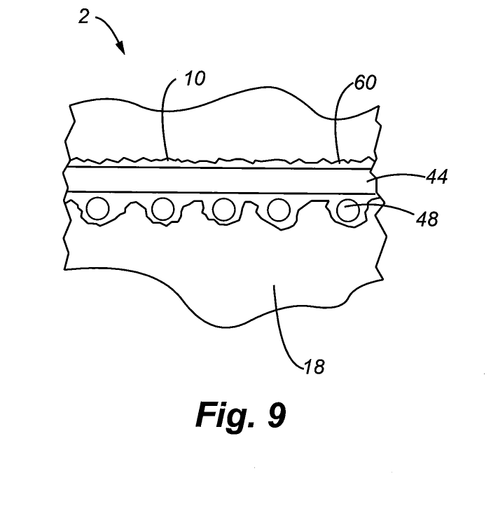

Referring now to FIG. 9, the finished reinforced insulative material 2 is provided. More specifically, FIG. 9 illustrates that a strong interfaced boundary 60 is provided by embodiments of the present invention. When the heated insulative material 18 is introduced to a mold containing the reinforcing mesh 6, the heat of the insulative material 18 causes melting of the coating 10 of the reinforcing mesh 6. After cooling, the melted interface boundary 60 creates a strong mechanical bond between the reinforcing mesh 6 and the insulative material 18. It is important to note that during the molding process, the heat provided by the insulative material 18 is only hot enough in some embodiments of the present invention to melt the outer portion of the coating 10, thereby preserving the integrity of the bond (i.e. beads 64) between the transverse 44 and longitudinal 48 fibers that make up the reinforcing mesh 6.

Referring now again to FIGS. 1-9, reinforced insulative material 2 of embodiments of the present invention are made of an insulative material 18, preferably expanded polystyrene foam (EPS). One skilled in the art will appreciate that other insulated materials, such as extruded polystyrene foam (XPS) may be employed as well. In operation, EPS pellets are taken from a hopper, heated and introduced into the mold 14 that contains the reinforcing mesh 6. In one embodiment of the present invention, the EPS is shaped by pumping warm prepped polystyrene beads into a closed cavity heated mold then chilled to cure the polystyrene beads into a predetermined shape. The mold may impart a surface texture onto the insulative material. For example, small irregular shaped holes may be added to the surfaces of the insulative material that will enhance the bond between the outer shell that encapsulates the insulative material such as plastic, concrete etc.

Embodiments of the present invention employ any number of reinforcing members into the mesh 6. Preferably, fiberglass 38 is utilized that is coated with polyvinyl chloride (PVC) 10. The heat of the molten EPS 18 is, in some embodiments, approximately equal to the melting point of PVC 10, thereby melting the PVC 10 and mechanically and/or chemically bonding it to the EPS 18. This marriage of PVC 10 and EPS 18 results in a composite insulative material with enhanced strength and in some applications allows for the thickness of the insulative material to be reduced, thereby decreasing the costs and weight of the final product while maintaining the strength. Alternatively, carbon fiber mesh may be added to the EPS foam insulation 18 to provide rigidity. Other materials that would provide rigidity are also contemplated by embodiments of the present invention and which one skilled in the art will appreciate could be used. In addition, many materials may be used with or without the coating of PVC. Further, one skilled in the art will appreciate the fiber orientation of the reinforcing mesh 6 may be altered depending on the final use of the reinforced insulation. Preferably, a fiberglass fiber 38 is used as oriented at 0 and 90 degrees, thereby providing approximately a square mesh 6. Alternatively, mesh 6 may be woven or positioned at 45 degree angles, thereby providing a diamond sheet to be used within the thickness of the insulation. Embodiments of the present invention include reinforcing members that are tensioned during molding to yield a pre-stressed reinforced insulation material.

As alluded to above, in one embodiment of the present invention insulative members are constructed by providing insulative material 18 of a predetermined temperature that possesses a melting point similar to or equal to that of the coating 10 provided on the reinforcing mesh 6. This allows the coating 10 and the insulative material 18 to create a strong bond therebetween. More specifically, and as stated above, when molten insulative material 18 is introduced to a mold containing the reinforcing mesh 6, the heat of the insulative material 18 causes surficial melting of the coating 10 of the reinforcing mesh 6, creating a melted interface boundary 60 between the coating 10 and the insulative material 18. This heat provides sufficient energy for the coating 10 and the insulative material 18 to physically intermingle at the interface boundary 60, creating a mechanical bond upon cooling that is stabilized by the physical intermingling and also by certain non-covalent intermolecular forces, such as van der Walls forces, generated by the close proximity of the molecules of the two substances. In some embodiments, the heat from the molten insulative material 18 also provides sufficient energy to induce chemical bonding, such as cross-links, between the coating 10 and the insulative material 18.

Preferably, both the coating 10 and the insulative material 18 are chain-growth, or addition, polymers, that are produced by radical-initiated chain-reaction polymerization and are even more preferably polymers of substituted ethylene monomers with regularly spaced substituent groups. In the presently preferred embodiment, the coating 10 is a polymer of chloroethylene monomers (H₂C═CHCl), or poly (vinyl chloride), and the insulative material 18 is a polymer of styrene monomers (H₂C═CHC₆H₅), or polystyrene. Both of these polymers, and particularly polystyrene, display chemical properties that are complicated in practice by the presence of numerous branches, which are created during polymerization by either intramolecular hydrogen atom abstraction within a single forming polymer chain or by reaction of the radical end of one nascent polymer chain with the middle of another polymer chain. These branches are created and can exist in a number of configurations and are typically stabilized by certain non-covalent intermolecular forces such as van der Walls forces. Therefore, when the coating 10 is contacted with the molten insulative material 18, the heat of the molten polystyrene provides sufficient energy to break these non-covalent intermolecular forces in the branched chains of each polymer, effectively denaturing the two polymers and allowing for greater intermingling between the branches of the two polymers at the interface boundary 60. The close proximity of the newly denatured branched chains of each polymer, together with the heat provided by the molten insulative material 18, allows the poly (vinyl chloride) and the polystyrene to chemically react, creating chemical cross-links between the branched chains of the two polymers. These cross-links are covalent chemical bonds that may be created at any number of sites between the two polymers, such as the backbone of one polymer and a substituent group of another, between the backbones of each polymer, and/or between the two substituent groups of each polymer. The cross-links may be created between the two polymers by way of the familiar chemistry of the functional groups of each polymer, including without limitation, standard electrophilic aromatic substitution reactions and nucleophilic substitution reactions such as S_{N}1 or S_{N}2 reactions.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims.

What is claimed is:

1. A method of manufacturing a reinforced low density foam material with a predetermined shape, comprising:
providing a mold with a first portion and a second portion which has a predetermined shape;
positioned a reinforcing material between said first portion and said second portion at a predetermined location;
closing said mold to retain said reinforcing material within the first portion and the second portion;
placing a volume of foam material at a predetermined temperature into said mold;
providing heat to the mold until it reaches a predetermined temperature;
bonding said reinforcing material to said foam within said mold;
cooling said reinforced low density foam material; and
removing said low density reinforced foam material from said mold.

2. The method of claim 1, wherein the low density foam material is comprised of an EPS material.

3. The method of claim 1, wherein said foam material comprises a plurality of foam pellets which are preheated to a predetermined temperature prior to injecting into said mold.

4. The method of claim 1, wherein said reinforcing material is comprised of at least one of a fiberglass, a polypropylene, a polyvinyl, a polyvinylchloride and a carbon fiber material.

5. The method of claim 1, wherein said reinforcing material is a fiberglass material coated with a polyvinyl chloride material.

6. The method of claim 1, wherein said reinforcing material is put in tension within said mold.

7. The method of claim 6, wherein said reinforcing material is held in tension between said first portion and said second portion of said mold.

8. A reinforced low density structure, comprising:
a low density foam material with a predetermined shape and having a first thickness defined by a distance between a first surface and a second surface; and
a reinforcing mesh positioned between said first and said second surface of said low density foam material.

9. The reinforced low density structure of claim 8, wherein said low density foam is an EPS material.

10. The reinforced low density structure of claim 8, wherein said foam material comprises a plurality of foam pellets which are preheated to a predetermined temperature prior to injecting into said mold.

11. The reinforced low density structure of claim 8, wherein said reinforcing mesh is comprised of at least one of a fiberglass, a polypropylene, a polyvinyl, a polyvinylchloride and a carbon fiber material.

12. The reinforced low density structure of claim 8, wherein said reinforcing mesh is a fiberglass material coated with a polyvinyl chloride material.
